(19) United States
(12) Patent Application Publication
(10) Pub. No.: US 2007/0147515 A1
(43) Pub. Date: Jun. 28, 2007

(54) Information processing apparatus

(76) Inventors: Yuji Kawashima, Ome-shi (JP); Yoshihiro Kikuchi, Ome-shi (JP); Tatsuro Fujisawa, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/638,856

(22) Filed: Dec. 13, 2006

(30) Foreign Application Priority Data
Dec. 27, 2005 (JP) 2005-375203

(51) Int. Cl. H04N 11/02; H04B 1/66

(52) U.S. Cl. 375/240.25; 375/240.29

(57) ABSTRACT

According to one embodiment, an information processing apparatus includes a decoder which decodes video coded data, and a load information acquisition means which acquires load information required for processing of data other than the video coded data, wherein the decoder predetermines elimination priorities of stepwise filter processing required for decoding the video coded data, obtains a load level from the load information, and in response to the obtained level, eliminates the filter processing in a stepwise manner in accordance with the priorities.

### CROSS-REFERENCE TO RELATED APPLICATIONS

This application is based upon and claims the benefit of priority from Japanese Patent Application No. 2005-375203, filed Dec. 27, 2005, the entire contents of which are incorporated herein by reference.

### BACKGROUND

1. Field

One embodiment of the present invention relates to an information processing apparatus equipped with a function of decoding video coded data.

2. Description of the Related Art

As a technique standardized for encoding a video, there have been developed: H. 261 and H. 263 of ITU-T (International Telecommunication Union, Telecommunication Standardization Division); and MPEG (Moving Picture Experts Group)-1, MPEG-2, MPEG-4 or the like of ISO (International Standardization Organization). As a next generation video encoding system further developed while inheriting the techniques such as H. 261 to 263 and MPEG-1 to -4, there is exemplified H. 264 in which standardization has been carried out jointly by the ISO and the ITU. In this H. 264, as one of an in-loop filters, there is employed a de-blocking filter for mitigating a distortion generated at a block boundary, and in particular, an image quality improvement effect at a low bit rate is enhanced. It is disclosed by, for example, ITU-T Recommendation H. 264 (2003), “Advanced Video Coding for generic audiovisual services”, ISO/IEC 14496-10: 2003, “Information technology, Coding of audio-visual objects—Part 10: Advanced video coding” and H. 264/AVC textbook (Impress Communications Co., Ltd.)

However, an information processing apparatus equipped with a video decode processing function that conforms to standardization specification based on H. 264 described above, actually, has a high rate of a processing quantity of an in-loop filter, particularly a de-blocking filter in the whole decoding process. Thus, in the case where a processing capability of a central processing unit (CPU) or a graphic controller is low or in the case where a whole processing load is high, decode processing in real time lags behind, and frame missing occurs or an object motion becomes extremely slow.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an example of a basic configuration of one embodiment of an information processing apparatus equipped with a function of decoding a video according to the present invention;

FIG. 2 is a block diagram depicting a specific example of a configuration of a video decoder shown in FIG. 1;

FIGS. 3A and 3B are views each adapted to explain an example of an edge filter-processed at a de-blocking filter section shown in FIG. 2;

FIGS. 4A and 4B are views each adapted to explain an example of filter processing at the de-blocking filter section shown in FIG. 2;

FIG. 5 is a flow chart showing an example of a method for eliminating procedures for filter processing of the de-blocking filter section shown in FIG. 2;

FIG. 6 is a flow chart showing a first embodiment of the filter processing eliminating method shown in FIG. 5;

FIG. 7 is a flow chart showing a second embodiment of the filter processing eliminating method shown in FIG. 6; and

FIG. 8 is a flow chart showing a third embodiment of the filter processing eliminating method shown in FIG. 6.

### DETAILED DESCRIPTION

Various embodiments according to the invention will be described hereinafter with reference to the accompanying drawings. In general, according to one embodiment of the invention, an information processing apparatus includes a decoder which decodes video coded data, and a load information acquisition means which acquires load information required for processing of data other than the video coded data, wherein the decoder predetermines elimination priorities of stepwise filter processing required for decoding the video coded data, obtains a load level from the load information, and in response to the obtained level, eliminates the filter processing in a stepwise manner in accordance with the priorities.

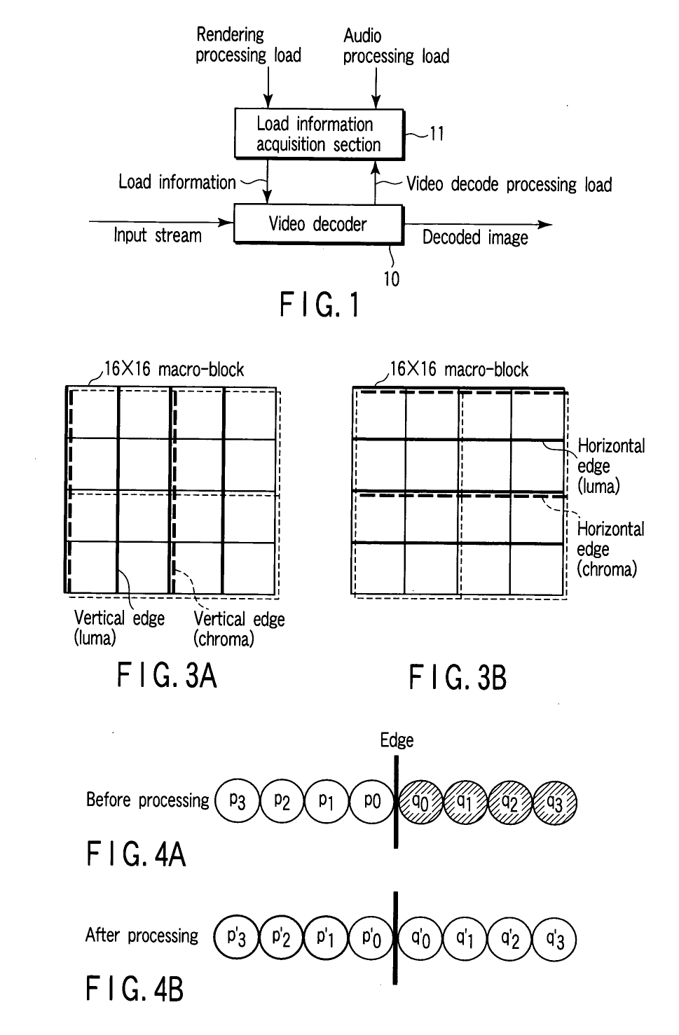

According to an embodiment, FIG. 1 is a block diagram depicting an example of a basic configuration of one embodiment of an information processing apparatus equipped with a function of decoding a video coded data according to the present invention. The information processing apparatus shown in FIG. 1 supplies a compressed/encoded video stream (video coded data) to be inputted from a transmission system to a video decoder 10 using a graphic controller that conforms to the standard specification based on H. 264, for example; carries out decode processing; and outputs the decoded data. At this time, the video decoder 10 notifies a processing load required for decoding to a load information acquisition section 11. This load information acquisition section 11 acquires information on a rendering processing load and an audio processing load in addition to a video decode processing load, and then, notifies the whole load information to the video decoder 10. The video decoder 10 predetermines elimination priorities of filter processing required for decode processing, based on parameters required for decode processing; obtains a load level from the load information; and then, eliminates filter processing in a stepwise manner in accordance with the priorities, in response to the obtained level.

Acquisition of load information can include: a technique of querying a load to an operating system executed on information processing; and a technique of detecting a load based on a use rate of either a processor or a memory, the processor executing information processing.

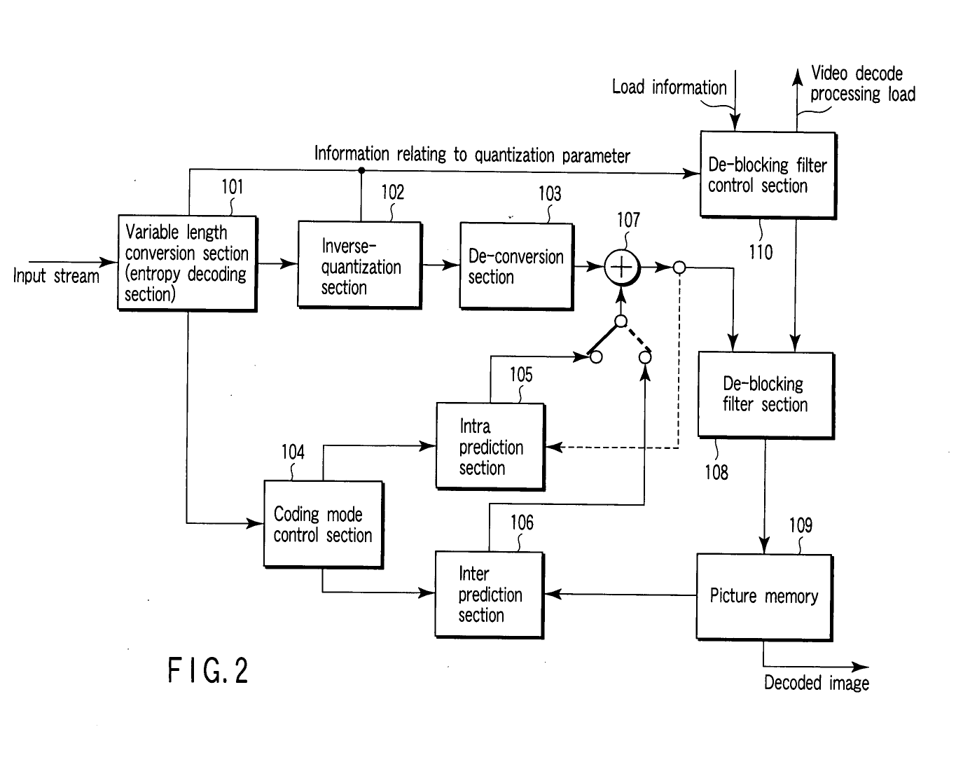

FIG. 2 is a block diagram depicting a specific configuration of the video decoder 10 described above. In FIG. 2, an input stream is provided as a stream compressed/encoded in accordance with the H. 264 standard, and sent to a variable length converting section 101 (also referred to as an entropy decoding section). This variable length converting section 101 carries out variable length decoding of an inputted video encoded stream, and then, generates syntax. A de-quantization section 102 and a de-conversion section 103 generate a residual image from a result of decoding the video encoded stream, based on the generated syntax. A coding mode control section 104 judges a coding mode from the decoding result of the variable length converting section 101.

In addition, an intra prediction section 105 and an inter prediction section 106 each generate intra and inter predictive images, respectively, in accordance with a coding mode specified by the coding mode control section 104. The generated predictive image is selectively sent to a residual adder section 107. This residual adder section 107 adds a predictive image from the intra prediction section 105 or inter prediction section 106 and a residual image from the de-conversion section 103, and then, generates a decoded image. The generated decoded image is referred to in the intra prediction section 105 and sent to a de-blocking filter section 108.

On the other hand, with respect to the de-blocking filter section 108, a de-blocking filter control section 110 presets stepwise processing levels relevant to the decoded image generated in advance in the residual adder section 107 in accordance with control information or the information relating to quantization parameters inputted from the variable length decoding section 101 and the inverse quantization section 102. Then, this control section sends to the load information acquisition section 11 the load information required for video decode processing from the information relating to the quantization parameters; receives whole load information from the acquisition section 11; and then, determines a processing level of the de-blocking filter based on that load level. The de-blocking filter section 108 eliminates the filter processing of the inputted decoded image in a stepwise manner, based on that determination. A reconstruction image filter-processed at the de-blocking filter section 108 is stored in a picture memory 109. The reconstruction image stored in the picture memory 109 is output as a decoded image or is referred to in the inter prediction section 106.

As described previously, the video encoding system that conforms to the H. 264 standard achieves a high compression rate by the combination of a number of encoding techniques, whereas it has a problem with a large amount of processing. In particular, as in HD-DVD (high resolution video image DVD), in the case of reproducing a video with high resolution, this problem becomes serious. Among the H. 264 decoders, de-blocking filter processing carries out computation with respect to block edges every four pixels, and thus, an amount of processing is very large. Therefore, the present invention is featured by detecting a load of a variety of processing operations carried out in video image processing such as DVD reproduction processing; and, in the case where a load of audio processing, rendering processing and the like is high, adaptively eliminating de-blocking filter processing, thereby reducing an amount of decoder processing.

That is, according to the above configured video decoder 10 of the present invention, the de-blocking filter control section 110 acquires a parameter “boundary strength” (hereinafter, referred to as “bS”) indicating filter strength as a quantizing parameter, and a clipping value “tc” of a pixel change rate; and then, carries out de-blocking filter processing with respect to a vertical edge (luma, chroma) and a horizontal edge (luma, chroma) of a 16×16 micro-block as shown in FIGS. 3A and 3B, for example. At this time, a boundary (edge), at which a change of a pixel value due to the de-blocking filter processing as shown in FIGS. 4A and 4B is small, is detected from the filter strength parameter “bS” and the clipping value “tc” of a pixel change rate; and then, the elimination of the de-blocking filter processing is applied preferentially in response to a level of a processing load. In this manner, it is possible to achieve a reduced number of processing blocks while preventing an error from being accumulated on a decoded image.

The parameter “bS” of filter strength of the de-blocking filter processing relevant to the above 16×16 macro-block is given as follows.

When bS=4, it follows:
p′₀=(p₂+2×p₁+2×p₀+2×q₀+q₁+4)>>3
p′₁=(p₂+p₁+p₀+q₀+2)>>2
p′₂=(2×p₃+3×p₂+p₁+p₀+q₀+4)>>3
q′₀=(p₁+2×p₀+2×q₀+2×q₁+q₂+4)>>3
q′₁=(p₀+q₀+q₁+q₂+2)>>2
q′₂=(2×q₃+3×q₂+q₁+q₀+p₀+4)>>3

When bS=1, 2, or 3, it follows:
Δ=clip₃(−t_{c}, t_{c}, ((((q₀−p₀)<<2)+(p₁−q₁)+4)>>3))
p′₀=clip1(p₀+Δ)
p′₁=p₁+clip3(−tc₀, tc₀, (p₂+((p₀+q₀+1)>>1)−(p₁<<1))>>1)
q′₀=clip1(q₀−Δ)
q′₁=q₁+clip3(−tc₀, tc₀, (q₂+((p₀+q₀+1)>>1)−(q₁<<1))>>1)

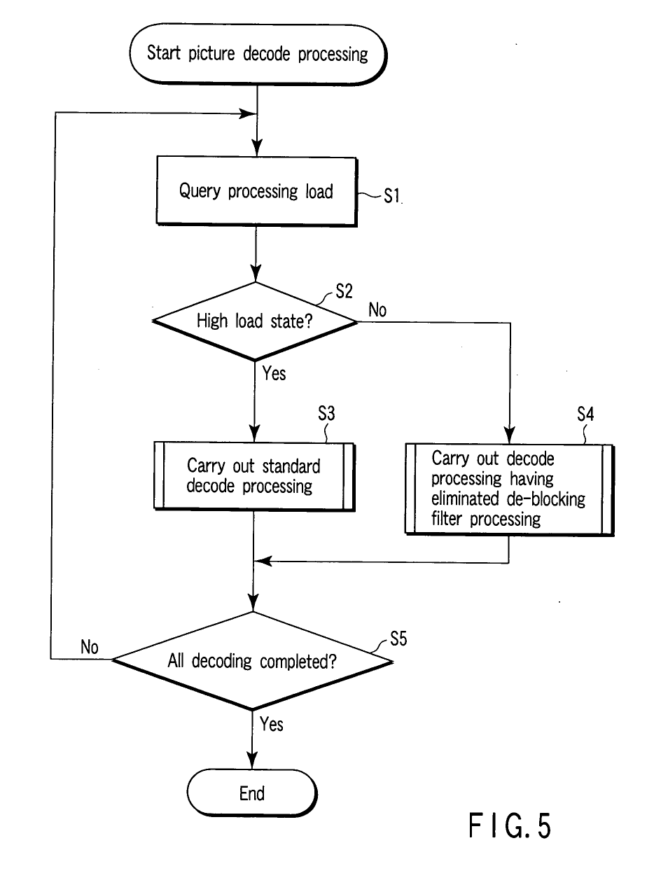

Now, with reference to FIG. 5, a description will be given with respect to a method for eliminating a de-blocking filter processing responsive to a load level according to the present invention.

First, a load state of whole equipment is queried at the time of starting decoding of each picture (block S1); and then, it is judged whether or not a high load state is established (block S2). In the case where the high load state is not established, standard decode processing (including de-blocking filter processing) is carried out (block S3). In the case where the high load state is established, decode processing having eliminated the de-blocking filter processing in a stepwise manner is executed in response to the corresponding load level, the parameter “bS” indicating filter strength, and the clipping value “tc” of a pixel change rate (block S4). The above-described processing is repeated until decoding of all pictures is completed (block S5).

Stepwise elimination of the above filter processing can be achieved in accordance with first to third embodiments.

### First Embodiment

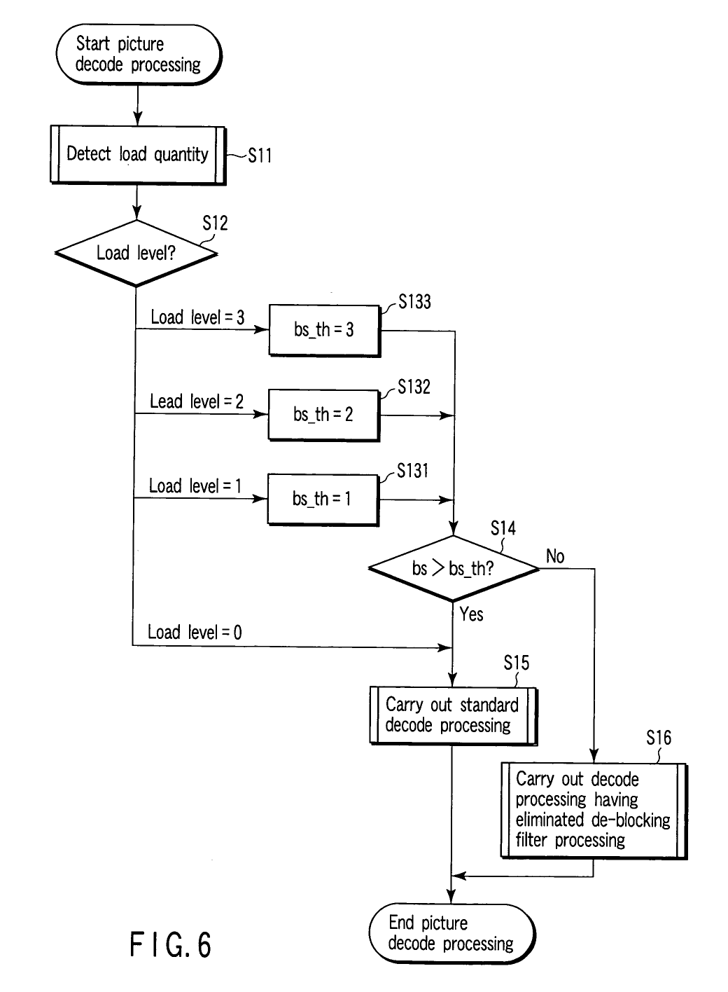

Filter strength parameters bS exist as 0 to 4. The larger value indicates the higher filter strength. As shown in FIG. 6, after detecting a load quantity (block S11), a load level is judged (block S12). Here, when the load level=1, bS_th=1 is preset; when the load level=2, bS_th=2 is preset; and when the load level=3, bS_th=3 is preset (blocks S131 to S133); and it is judged whether or not the actually acquired parameter bS is bS>bS_th (block S14). If bS>bS_th, standard decode processing (including de-blocking filter processing) is carried out (block S15). If bS>bS_th is not established, it is judged that a high load state is established, and then, filter processing is executed at a load level that corresponds to the bS value (block S16). When the load level is 0, standard decode processing (block S15) is carried out.

### Second Embodiment

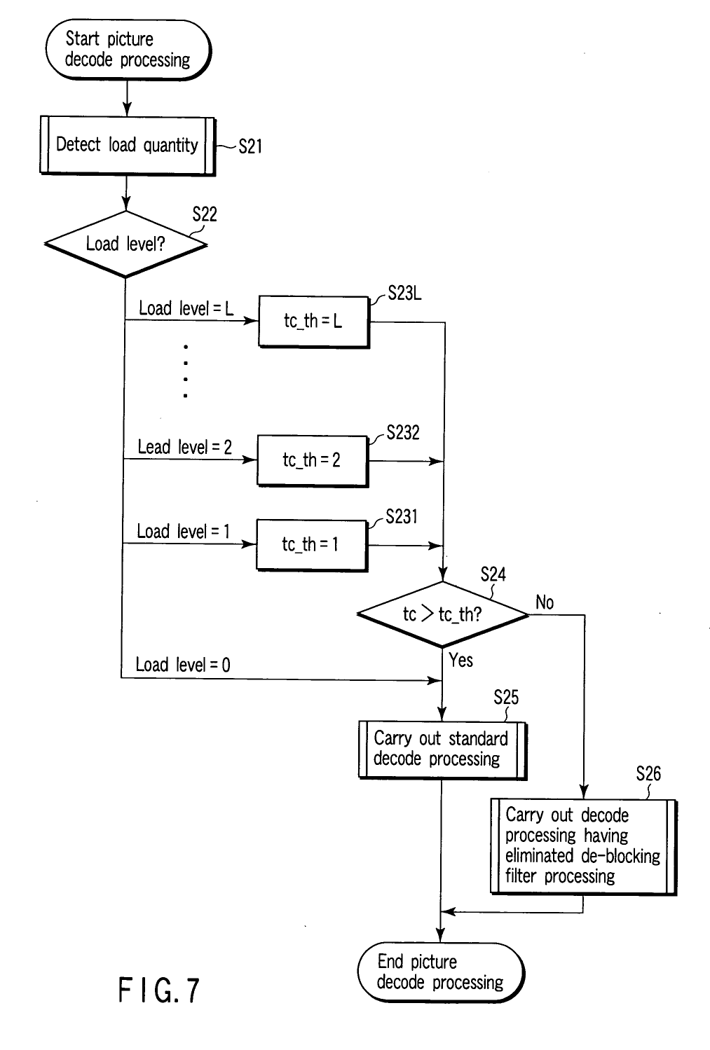

A clipping value “tc” of a pixel change rate is provided as a parameter that exists in the case where a filter strength parameter bS is within the range of 1 to 3. This parameter indicates a clipping value of a pixel change rate with respect to a filter target pixel. Therefore, the larger clipping value tc indicates the higher filter strength. As shown in FIG. 7, after detecting a load quantity (block S21), a load level is judged (block S22). Here, when the load level=1, tc_th=1 is preset; when the load level=2, tc_th=2 is preset; and when the load level=L, tc_th=L is preset (blocks S231 to S23L); and it is judged whether or not the actually acquired parameter tc is tc>tc_th (block S24). If tc>tc_th, standard decode processing (including de-blocking filter processing) is carried out (block S25). If tc>tc_th is not established, it is judged that a high load state is established, and then, filter processing is executed at a load level that corresponds to the tc value (block S26). When the load level is 0, standard decode processing (block S25) is carried out.

### Third Embodiment

A pixel change rate increases at an edge having higher filter strength. Thus, in the case of eliminating de-blocking filter processing, a pixel error is accumulated, and then, a difference from a correct decoded image becomes large. Therefore, de-blocking filter processing relevant to an edge having small filter strength is eliminated preferentially.

An evaluation value “e” obtained by the formula below is a value proportional to the filter strength “bS”. Therefore, de-blocking filter processing is eliminated with respect to an edge having the evaluation value “e” that is smaller than a threshold value θ.
e=γ×bS+φ×tc
θ=f (L) (load level)

In the formula, γ and φ are constants equal to or greater than 0. θ is determined by a function f (L) that returns a larger value as a load level increases. In the formula, although “tc” has been used as a parameter, tc0 may also be used.

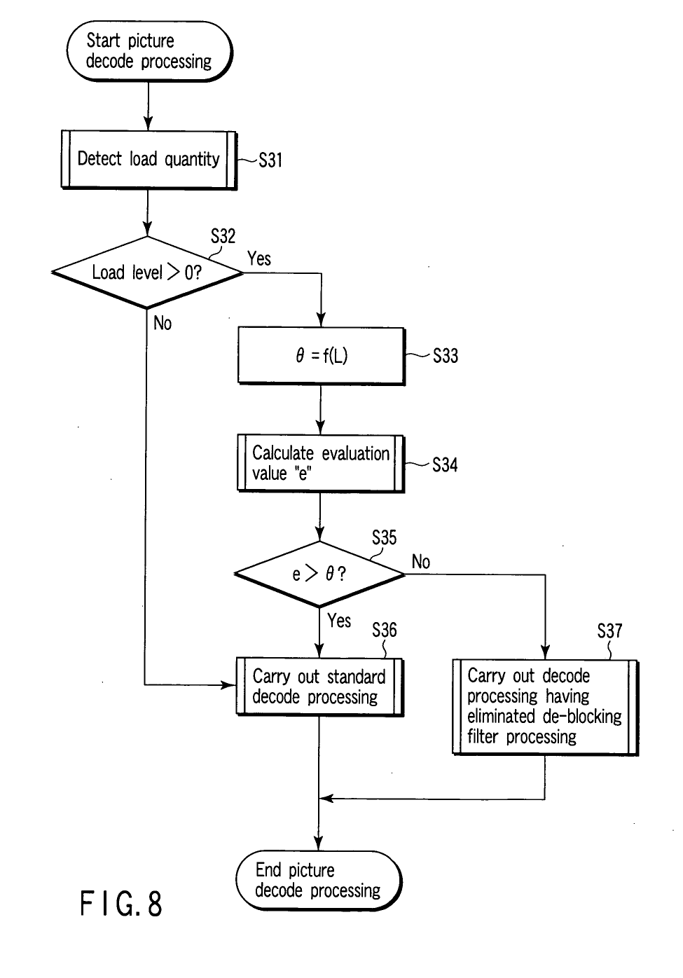

A flow of processing operation according to the third embodiment is shown in FIG. 8. First, after detecting a load quantity (block S31), a load level L>0 is judged (block S32). When the load level L>0 in advance, a threshold value θ is defined as θ=f (L) (block S33); an evaluation value “e” is calculated from the above formula (block S34); and the calculated value is compared with the threshold value θ (block S35). In this comparison, if e>θ, standard decode processing (including de-blocking filter processing) is carried out (block S36). If e>θ is not established, it is judged that a high load state is established, and then, filter processing that corresponds to that load level is executed (block S37). In the case where the load level L>0 is not established in block S32, standard decode processing (block S36) is carried out.

As described above, in the first embodiment, assuming that control of de-blocking filter processing is carried out using a load level and bS, the de-blocking filter processing is executed only at an edge in which the higher load level indicates the higher “bS”. In the second embodiment, assuming that control of de-blocking filter processing is carried out using a load level and a clipping value “tc” of a pixel change rate, the de-blocking filter processing is executed only at an edge in which the higher load level indicates the higher “tc”. In the third embodiment, assuming that control of de-blocking filter processing is carried out using both of a load level and bS and the clipping value “tc” of a pixel change rate, a threshold value θ, which is larger as the load level is higher, and an evaluation value are compared with each other, and de-blocking filter processing is executed only at an edge having an evaluation value “e” that is greater than θ.

In any embodiment, in response to a level of a processing load, de-blocking filter processing can be eliminated preferentially in a stepwise manner, and a reduced number of processing blocks can be achieved while preventing error accumulation of a decoded image.

As has been described above, according to the present invention, the priorities of eliminating filter processing is predetermined based on parameters required for decoding of the video coded data; a load level is obtained from load information required for processing of data other than the video coded data; and in response to that level, filter processing is eliminated in a stepwise manner in accordance with the priorities, whereby a load of filter processing is reduced in a stepwise manner in response to another data processing load level so as not to have an effect on a decode processing speed. As a result, while promoting image quality improvement at a low bit rate, in-loop filter processing is carried out in a stepwise manner, and then, filter processing is reduced in response to a load level of a whole system, thereby making it possible to properly carry out decode processing in real time. In addition, for use in a portable computer, if information such as battery residue or power saving mode is monitored as part of load information, decode processing can be effectively continued while reducing power consumption of video decode processing when the battery residue is short or when power saving mode is selected.

The decode processing described above is applicable in the case where it is carried out in any of CPU and a graphic controller. In addition, the decode processing can be achieved as the video decode processing function as described above. At the same time, the above decode processing can be achieved as a video decoding method comprising as means the characterizing blocks included in the video decoding method. In addition, the above processing can be implemented as a program that causes a computer to execute these blocks. In addition, such a program can be distributed via a recording medium such as CD-ROM or a transmission medium such as the Internet.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a decoder which decodes video coded data; and
a load information acquisition means configured to acquire load information required for processing of data other than the video coded data,
wherein the decoder predetermines elimination priorities of stepwise filter processing required for decoding the video coded data, obtains a load level from the load information, and in response to the obtained level, eliminates the filter processing in a stepwise manner in accordance with the priorities.

2. The information processing apparatus according to claim 1, wherein the decoder comprises:
a prediction means which generates a predictive image in accordance with a coding mode decoded from the video coded data;
an inverse quantization/inverse transformation means which generates a residual image from quantized orthogonal transform coefficients decoded from the video coded data;
a residual adder-which adds the predictive image and the residual image to generate a decoded image; and
a filter processor which carries out filter processing for reducing a block distortion of the decoded image in a stepwise manner, and
the filter processor comprises:
detecting a level of a processing load from load information acquired by the load information acquisition means;
detecting a boundary at which a change of a pixel value using the filter processing is small from parameters required for the filter processing; and
sequentially eliminating boundaries from a boundary at which a change of the pixel value is small, in response to a level of the processing load, and then, carrying out filter processing.

3. The information processing apparatus according to claim 2, wherein the filter processor uses at least one of filter strength and a clipping value of a pixel change rate as a parameter required for the filter processing.

4. The information processing apparatus according to claim 1, wherein the load information acquisition means queries a load level to an operating system executed on information processing.

5. The information processing apparatus according to claim 1, wherein the load information acquisition means detects the load level based on a use rate of at least either of a processor and a memory, the processor executing the information processing.

6. The information processing apparatus according to claim 1, wherein the decoder inputs and decodes data based on H. 264 recommended by ITU (International Telecommunication Union, Telecommunication Standardization Division) as the video coded data.

7. An information processing apparatus comprising:
a processor which carries out decode processing of a video coded data; and
a load information acquisition means configured to acquire load information required for processing of data other than the video coded data during a period in which the processor executes a program,
wherein the processor comprises:
decoding the video coded data to generate a predictive image;
de-quantizing and inverse transform a quantized orthogonal transform coefficient from the video coded data to generate a residual image;
adding the predictive image and the residual image to generate a decoded image; and
carrying out filter processing for reducing a block distortion of the decoded image in a stepwise manner, and
the filter processing comprises:
detecting a level of a processing load from the load information acquired by the load information acquisition means;
detecting a boundary at which a change of a pixel value using the filter processing is small, from parameters required for the filter processing; and
sequentially eliminating boundaries from a boundary at which a change of the pixel value is small, in response to a level of the processing load, and then, carrying out filter processing.

8. A computer-readable memory containing program instructions for decoding video coded data, the memory comprising:
performing a function of decoding the video coded data to generate a predictive image;
performing a function of inverse quantization and inverse transforming a orthogonal transform coefficient quantized from the video coded data to generate a residual image;
performing a function of adding the predictive image and the residual image to generate a decoded image; and
performing a function of carrying out filter processing for reducing a block distortion of each screen of the decoded image in a stepwise manner,
the filter processing comprising:
performing a function of detecting a level of a processing load from load information required for processing of data other than the video coded data;
performing a function of detecting a boundary at which a change of a pixel value using the filter processing is small, from parameters required for the filter processing; and
performing a function of sequentially eliminating boundaries from a boundary at which a change of the pixel value is small, in response to a level of the processing load, and then, carrying out filter processing.
